(19) United States
(12) Patent Application Publication
(10) Pub. No.: US 2020/0172151 A1
(43) Pub. Date: Jun. 4, 2020

(54) STEERING SYSTEM RACK WITH FLATTENED PORTION

(71) Applicant: Steering Solutions IP Holding Corporation, Saginaw, MI (US)

(72) Inventors: Michael J. Augustine, Mayville, MI (US); Kevin P. Douglas, Bay City, MI (US); William H. Georges, Saginaw, MI (US); William S. Anders, Merril, MI (US)

(21) Appl. No.: 16/206,279

(22) Filed: Nov. 30, 2018

(51) Int. Cl. B62D 3/12; B62D 5/04; B21K 1/76

(52) U.S. Cl. CPC B62D 3/126; F16H 55/26; B21K 1/767; B62D 5/0448

(57) ABSTRACT

A rack bar blank for a steering system is provided. The rack bar blank includes a first region having a circular cross-section. The rack bar blank also includes a second region having a flattened surface along a length thereof, the flattened surface present prior to formation of teeth.

### BACKGROUND

The embodiments described herein relate to vehicle steering systems and, more particularly, to a rack blank with a flattened portion for vehicle steering systems.

Steering systems that employ a ball screw to convert rotary steering assist power into a linear output, which may be referred to as rack assist electric power steering (REPS), require that the rotary motion of the ball screw be constrained to generate axial motion of the same. Two common approaches are used in the automotive industry to accomplish this. First, a steering pinion, engaged with a toothed portion of a cylindrical mating rack that is directly coupled to the ball screw, provides not only mechanical feedback to the steering system, but also 100% of the ball-screw torque reaction. Second, a non-cylindrical section mating rack with two symmetric flats added to its section, which is directly coupled to the ball screw, provides partial ball-screw torque reaction when interfaced with a complementary shaped plunger (e.g., rack shoe). The rack flats are oriented to be substantially non-orthogonal to the plunger motion direction. The pinion provides the needed additional torque reaction. Tie rod orientation that generates reaction forces that are substantially normal to the rack shoe increase the pinion reaction in the system.

In these systems, ball screw torque results in highly localized contact in the rack and pinion mesh. As assist levels (ball-nut torque) increase in such systems, the contact stresses associated with the localized contact can exceed the material capacity, resulting in high wear and reduced durability at the rack and pinion mesh location.

### SUMMARY

According to an aspect of the disclosure, a rack bar blank for a steering system is provided. The rack bar blank includes a first region having a circular cross-section. The rack bar blank also includes a second region having a flattened surface along a length thereof, the flattened surface present prior to formation of teeth.

According to another aspect of the disclosure, a method of forming a rack bar for a steering system is provided. The method includes deforming a circular rack bar blank to include a flattened surface along a length thereof. The method also includes cutting a plurality of teeth along and into the flattened surface.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of a vehicle steering system;

FIG. 2 is a perspective view of a rack of the vehicle steering system;

FIG. 3 is a cross-sectional view of the rack taken along line A-A of FIG. 2;

FIG. 4 is a sectional view of the rack illustrating dimensions of the rack; and

FIG. 5 is a perspective view of the rack according to another aspect of the disclosure.

### DETAILED DESCRIPTION

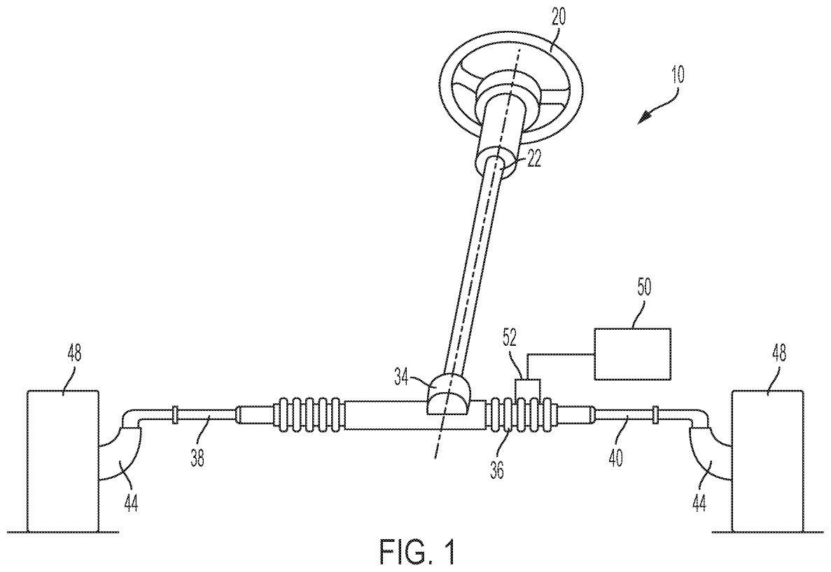

Referring now to the Figures, where the invention will be described with reference to specific embodiments, without limiting same, FIG. 1 illustrates a vehicle steering system 10 that is provided to steer a vehicle in a desired direction. The steering system 10 may include a hand wheel 20 operatively connected to a gear housing 34 via a steering column 22. The steering column 22 may be formed with one or more column sections, such as an upper column and a lower column, for example, but it is to be appreciated that various numbers of column sections may be employed. Also included is a steering mechanism, part of which is a toothed rack bar 36, tie rods 38, 40, steering knuckles 44, and road wheels 48.

The steering system 10 is an electric power steering system that utilizes a rack and pinion steering mechanism, which includes the toothed rack bar 36 and a pinion gear (not shown) located under gear housing 34. During operation, as hand wheel 20 is turned by a vehicle operator, the steering column 22 turns the pinion gear. Rotation of the pinion gear moves the toothed rack bar 36, which moves tie rods 38, 40. Tie rods 38, 40 in turn move respective steering knuckles 44, which turn the respective road wheels 48. It is to be appreciated that the steering system 10 may include fewer or more shaft or column components. Furthermore, as described above, in some embodiments a physical connection is not provided between the hand wheel 20 (or other steering input device) and a lower/forward portion of the steering column 22.

The steering system 10 includes a power steering assist assembly that assists steering effort with a motor 50 that drives a ball-screw assembly. In particular, a nut 52 is engaged with a ball screw portion of the rack bar 36 to assist with translation of the rack bar 36.

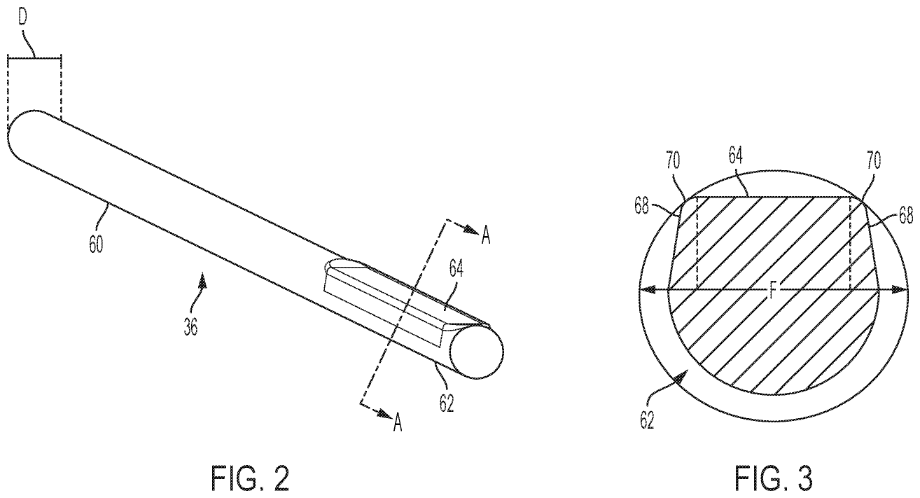

Referring now to FIG. 2, a blank of the rack bar 36 is illustrated to show the rack bar 36 prior to inclusion of the teeth of the rack bar 36. The blank of the rack bar 36 includes a ball screw region 60 along a length thereof and a discrete pinion mesh region 62 along a length thereof. The ball screw zone 60 is a region of the rack bar 36 that will include a ball screw thread form that is kinematically engaged with the nut 52 through a series balls in a recirculating ball circuit for powered steering assist. The pinion mesh region 62 is a region of the rack bar 36 that will include teeth that are in meshed engagement with the pinion of the rack and pinion mechanism.

The pinion mesh region 62 of the blank includes a flattened surface 64, as shown in the sectional view of FIG. 3. The flattened surface 64 may be completely flat in some embodiments (within manufacturing capabilities), but may have slight curvature in other embodiments.

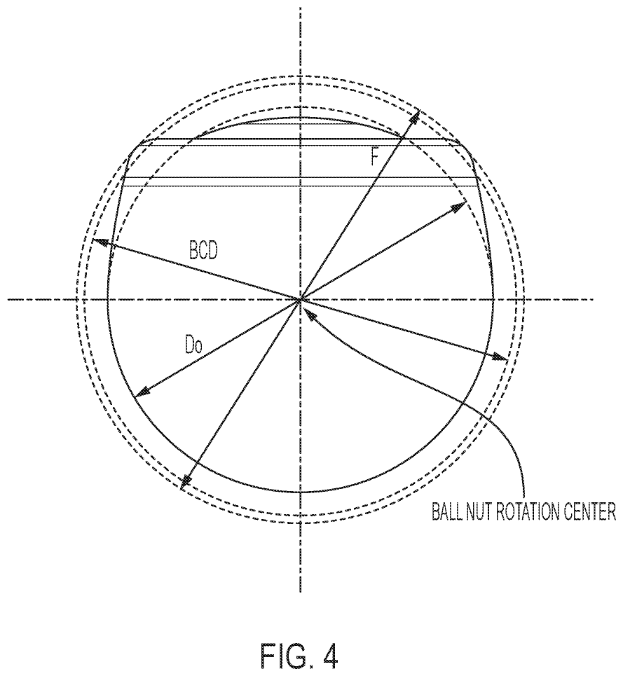

Referring now to FIG. 4, as the balls operate in the ball circuit, the radial position of their centers is maintained at a ball circle diameter (BCD) with respect to the axis of rotation by the thread forms of the ball screw and ball nut. The radial extent of the pinion mesh region 62 will increase relative to the rotation center in relation to the BCD such that the maximum radial extent is always greater than the outer diameter Do (FIG. 2) of the ball screw zone 60 before the BCD is established by rolling or grinding of the ball screw thread form. The maximum radial extent refers to a largest diametrical distance of the pinion mesh region 62, as represented with F in FIGS. 2 and 3.

Regardless of the particular dimensional relationships or whether the flattened surface 64 is completely flat or slightly curved, the effective face width of the rack teeth—upon formation—are substantially increased when compared to a standard round bar. Increasing the effective face width of the rack teeth increases the reaction torque capability of each tooth end by lowering the mating pinion's local ball-nut torque reaction force. This torque reaction force is reduced in proportion to the increased face width, thereby lowering the individual reactive loads and reducing the potential for pinion and rack tooth wear or fatigue damage. Therefore, the tooth end of the rack bar's shape increases torque reaction capability in proportion to the top width by redistributing the rack bar's mass. The functional load range is increased with such mass redistribution prior to tooth formation.

A method of forming the rack bar 36 includes deforming a circular rack bar blank by pressing or forming the flattened surface 64. Subsequently, the teeth of the pinion mesh region 62 are formed. The rack bar 36 may be formed with a single, integrally formed rack bar blank in some embodiments. In other embodiments, the two regions—ball screw region 60 and pinion mesh region 62—of the rack bar 36 may be separately formed and coupled in any suitable manner.

As shown in FIG. 3, the pinion mesh region 62 of the rack bar 36 may have a substantially D-shaped cross-section. The rounded shape of the circular rack bar blank are maintained opposite the flattened surface 64, but one or more angled flat portions 68 may be formed for clamping and orienting the rack bar 36 for subsequent manufacturing operations. As shown, a convex surface 70 on each side of the flattened surface 64 joins the flattened surface 64 with the angled flat portion(s) 68.

In other embodiments, a flat surface may join the flattened surface 64 with the angled flat portion (s) 68.

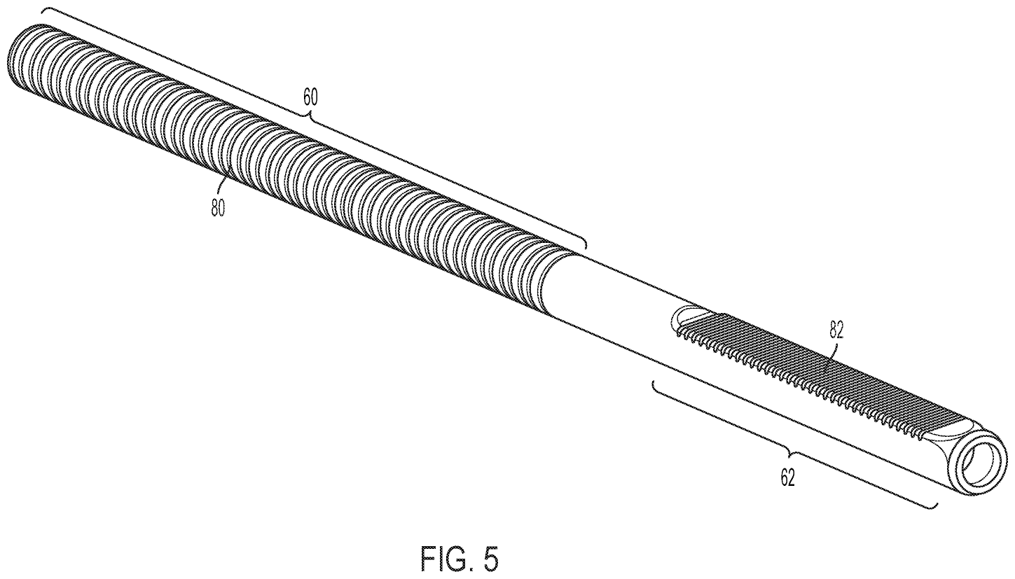

FIG. 5 shows the rack bar 36 in a substantially final form. In particular, the rack bar 36 is shown after formation of the ball screw thread 80 on the ball screw region 60 and the teeth 82 on the pinion mesh region 62.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

Having thus described the invention, it is claimed:

1. A rack bar blank for a steering system, the rack bar blank comprising:
a first region having a circular cross-section; and
a second region having a flattened surface along a length thereof, the flattened surface present prior to formation of teeth.

2. The rack bar blank of claim 1, wherein the first region is a ball screw region engageable with a ball screw nut upon formation of a ball screw thread form thereon, the second region engageable with a pinion upon formation of teeth thereon.

3. The rack bar blank of claim 1, further comprising an angled flat portion disposed on one side of the second region.

4. The rack bar blank of claim 3, wherein the flattened surface is joined to the angled flat portion with a flat transition.

5. The rack bar blank of claim 3, wherein the flattened surface is joined to the angled flat portion with a convex transition.

6. The rack bar blank of claim 1, wherein a maximum radial extent of the second region with respect to a ball screw axis is greater than an outer diameter of the first region prior to the processing of ball screw thread form to the first region.

7. A method of forming a rack bar for a steering system comprising:
deforming a circular rack bar blank to include a flattened surface along a length thereof; and
cutting a plurality of teeth along and into the flattened surface.

8. The method of claim 7, wherein cutting the plurality of teeth along and into the flattened surface is done subsequent to forming the flattened surface.

9. The method of claim 8, wherein the flattened surface is along a pinion mesh region, the circular rack bar blank also including a circular ball screw zone.

10. The method of claim 9, further comprising forming a ball screw thread along the circular ball screw zone.

11. The method of claim 9, wherein forming the flattened surface causes a maximum radial extent of the pinion mesh region with respect to a ball screw axis is greater than an outer diameter of the circular ball screw zone prior to forming the ball screw thread form of the ball screw zone.
